(19) United States
(12) Patent Application Publication
(10) Pub. No.: US 2008/0206536 A1
(43) Pub. Date: Aug. 28, 2008

(54) Poly (Aryl Ether Sulfone) Material And Use Thereof

(75) Inventor: Shari Weinberg, Kodaira-shi, GA (US)

Correspondence Address: OBLON, SPIVAK, MCCLELLAND MAIER & NEUSTADT, P.C., 1940 DUKE STREET, ALEXANDRIA, VA, 22314, US

(73) Assignee: SOLVAY ADVANCED POLYMERS, L.L.C., Alpharetta, GA (US)

(21) Appl. No.: 11/816,131

(22) PCT Filed: Feb. 15, 2006
(86) PCT No.: PCT/EP2006/050974

§ 371 Date: Feb. 20, 2008

Related U.S. Application Data
(60) Provisional application No. 60/653,137, filed on Feb. 16, 2005.

(51) Int. Cl. B32B 27/00; C08L 81/06

(52) U.S. Cl. 428/220; 525/535

(57) ABSTRACT

High-performance thin film Film having a thickness of below 100 μm, containing a polymer composition (C) containing a poly(aryl ether sulfone) material (P), composed of at least one poly(biphenyl ether sulfone) (P1), or at least one poly(biphenyl ether sulfone) (P1) and at least one poly(aryl ether sulfone) (P2) different from poly(biphenyl ether sulfone) (P1), and at least one fluorocarbon polymer.

### REFERENCE TO RELATED APPLICATIONS

This application claims priority to U.S. provisional application 60/653,137 filed Feb. 16, 2005, the whole content of which is incorporated herein by reference.

The present invention relates to a high-performance thin film, suitable notably for bagging various insulation materials included in some parts of aircrafts.

The industry, in particular the aircraft industry, uses profitably various materials, like glass fiber, to make insulative batting of various industrial parts against heat, sound and/or moisture. Because of their physical form (e.g. fibrous or particulate) and also to protect them from moisture, these insulating materials need usually to be wrapped. A polymer film is preferably used to form the bag. The polymer film needs usually to be thin, because the polymer, even if intrinsically exhibiting a fairly high fire and flame retardance, behaves usually somewhat poorer in a fire than the content of the bag itself (e.g. glass fiber), and because the industry, in particular the aircraft industry, is requiring parts made from more and more fire resistant materials.

Since the thin bagging film is exposed or susceptible to be exposed in severe environments, it should desirably meet a wide combination of various mechanical, thermal and/or chemical properties, despite of its low thickness.

Currently, thin bagging films made from metallized PET (available notably as MYLAR® products) are often used by the manufacturers of aircraft parts. However, in general, thin bagging films made from metallized PET are no more satisfactory for the encompassed end use, in particular because they do often not exhibit sufficient flame retardance, in compliance of the new requirements. These ones were settled notably with the aim at increasing the time for a post-crash external fuel fire to penetrate the fuselage to the interior as well as to eliminate the propagation of flight fires that begin between the interior walls and the external fuselage of an aircraft.

Other polymers have then been attempted for making thin bagging films in replacement of metallized PET, in particular PVF (commercially available notably as TEDLAR® polymers). However, thin bagging films made from PVF are generally disliked by aircraft manufacturers, in particular because they emit fairly high toxic fumes when burning. Further, there are limitations on how PVF films can be manufactured, such that their thickness must be not less than at least 50 μm.

Thin bagging films made polyimides, such as KAPTON® resins, have also been made and have proved to be unsuitable in most cases, in particular because of insufficient toughness and insufficient toughness resistance after repeated exposure to moisture condensate.

Thus, there is currently a strong need in the industry, in particular in the aircraft industry, for a thin film, suitable notably for bagging various insulation materials included in some parts of aircrafts, which meets several, and preferably all, out of the following requirements:
easiness of manufacturing, including high processibility of the material from which the film is made,
high toughness, including after exposure to moisture condensate,
high tear resistance, including after fatigue cycles,
high fire resistance, in particular high flame retardance,
low toxicity during burning,
passing rating for the radiant panel flame propagation test,
moderate cost, and
regular surface aspect (in particular, the surface must be essentially free, if not totally free, of bumps),
   in substantial progress with the prior art thin films.

Especially when the film to be made needs to be very thin, the quality of its surface aspect may be one of the most critical properties, if not sometimes the most critical one.

In certain applications, the thin film should further offer high chemical resistance to chemical agents, notably to strong acids, strong bases, aliphatic hydrocarbons and aromatic hydrocarbons, and have high hydrolytic stability.

The challenge of meeting several, if not all, the above requirements appeared to be especially tricky for the Applicant, since attempts to improve some of the above properties, resulted generally in a degradation of some other ones.

Yet, an excellent balance of properties is achieved, and even all the above requirements are often met, and possibly still other additional ones, by a film having a thickness of below 100 μm, containing a polymer composition (C) containing
a poly(aryl ether sulfone) material (P), composed of
   at least one poly(biphenyl ether sulfone) (P1), or
   at least one poly(biphenyl ether sulfone) (P1) and at least one poly(aryl ether sulfone) (P2) different from poly(biphenyl ether sulfone) (P1), and
at least one fluorocarbon polymer.

The thickness (t) of the film is advantageously defined as:

t=∫^{v}τ(x,y,z)dx dy dz/V,

wherein x, y and z are the coordinates in a three-dimensional space of an elementary volume dV (dV being equal to dx times dy times dz) of the film of overall plain volume V, and τ is the local thickness.

The local thickness τ, associated to a material point of coordinates (x,y,z), is defined as the length of the shortest straight line D including the material point of concern, which goes right through the film (i.e. which goes from the material point where D enters the film to the material point where D exits the shaped article).

It will be understood that the film according to the instant invention is not coated on a substrate. Thin layers of material which are coated on a substrate, commonly referred to as coatings, differ from the invented films. Coatings are usually produced by solution processing; in contrast, and as will be detailed hereafter, the invented film are usually prepared by melt processing.

The thickness of the film is preferably less than 50 μm, more preferably less than 30 μm and still more preferably less than 20 μm.

Besides, the thickness of the film is advantageously greater than 1 μm, preferably greater than 2 μm, more preferably greater than 3 μm and still more preferably greater than or equal to 4 μm.

A most preferred thickness range is from 4 to 8 μm.

Another most preferred thickness range is above 8 and up to 16 μm.

Optionally, the film may contain locally some zones, e.g. at its extremities or along its perimeter, which are composed at least one material other than polymer composition (C), e.g. in a metal or in a thermoplastic material free of poly(biphenyl ether sulfone) and/or of fluorocarbon polymer.

Polymer composition (C) is contained in the film in an amount of advantageously more than 50 wt. %, based on the total weight of the film. Preferably, the film consists essentially of polymer composition (C). Still more preferably, the film consists of polymer composition (C).

### The Poly(Aryl Ether Sulfone) Material.

As previously mentioned, polymer composition (C) contains a poly(aryl ether sulfone) material (P).

For the purpose of the invention, a poly(aryl ether sulfone) material is intended to denote one or more polycondensation polymer(s) of which more than 50 mol. % of the recurring units contain at least one ether group (—O—), at least one sulfone group (—SO₂—) and at least one arylene group.

Poly(aryl ether sulfone) material (P) is contained in polymer composition (C) in an amount of advantageously more than 50 wt. %, preferably more than 70 wt. %, and more preferably more than 85 wt. %, based on the total weight of polymer composition (C).

As previously mentioned, poly(aryl ether sulfone) material (P) contains at least one poly(biphenyl ether sulfone) (P1).

For the purpose of the invention, a poly(biphenyl ether sulfone) is intended to denote a polycondensation polymer of which more than 50 mol. % of the recurring units are recurring units (R1), wherein recurring units (R1) are those containing at least one ether group (—O—), at least one sulfone group (—SO₂—) and at least two groups (G) chosen from phenylene, naphthylenes (such as 2,6-naphthylene), anthrylenes (such as 2,6-anthrylene) and phenanthrylenes (such as 2,7-phenanthrylene), naphthacenylenes and pyrenylenes, each of said groups (G) being joined to at least one group (G) different from itself, directly by at least one single bond and, optionally in addition, by at most one methylene group. Accordingly, groups (G) may thus be joined together to form notably biphenylene groups such as p-biphenylene, 1,2′-binaphthylene groups, triphenylene groups such as p-triphenylene and fluorenylene groups (i.e. divalent groups derived from fluorene).

Recurring units (R1) are preferably those containing at least one ether group (—O—), at least one sulfone group (—SO₂—) and at least one p-biphenylene group:

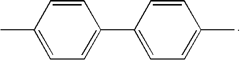

Recurring units (R1) are more preferably:

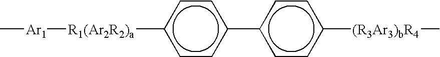

wherein R₁ through R₄ are —O—, —SO₂—, —S—, —CO—, with the proviso that at least one of R₁ through R₄ is —SO₂— and at least one of R₁ through R₄ is —O—; Ar₁, Ar₂ and Ar₃ are arylene groups containing 6 to 24 carbon atoms, and are preferably phenylene or p-biphenylene; and a and b are either 0 or 1.

For certain invented films, it is still more preferred that recurring units (R1) are:

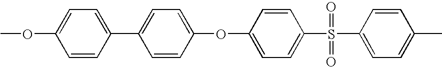

For certain other invented films, it is still more preferred that recurring units (R1) are:

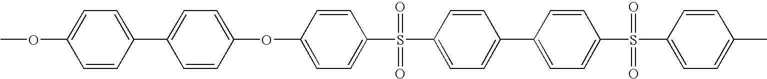

Optionally, poly(biphenyl ether sulfone) (P1) further comprises recurring units (R2) [different from recurring units (R1)].

Recurring units (R2) are preferably chosen from:

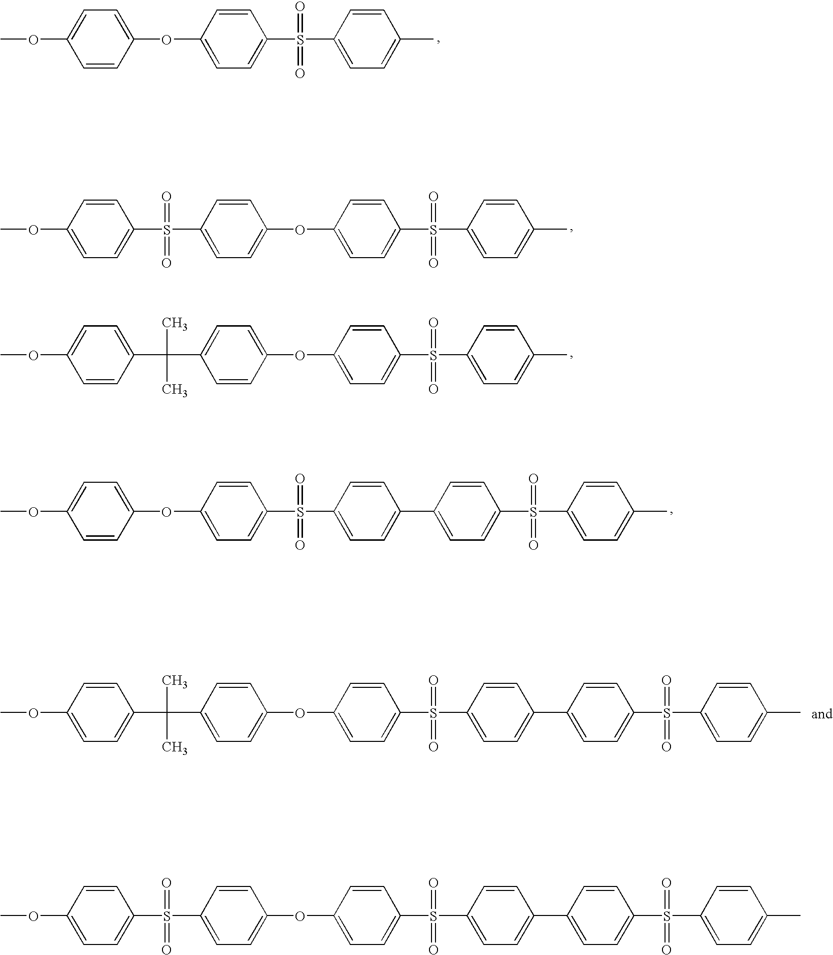

Poly(biphenyl ether sulfone) (P1) may notably be a homopolymer, a random, alternating or block copolymer.

Preferably at least 70 wt. %, more preferably at least 85 wt. % of the recurring units of the poly(biphenyl ether sulfone) (P1) are recurring units (R1). Still more preferably, poly(biphenyl ether sulfone) (P1) is a homopolymer of recurring units (R1).

For certain invented films, excellent results were obtained with homopolymers the recurring units of which are:

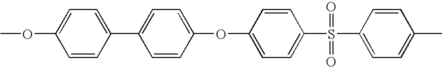

RADEL® R polyphenylsulfone from Solvay Advanced Polymers, L.L.C. is an example of the above homopolymer.

For certain other invented films, excellent results are obtained with homopolymers the recurring units of which are:

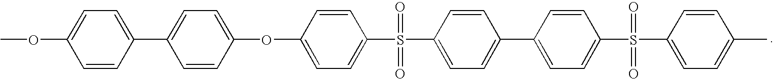

As previously mentioned, poly(aryl ether sulfone) material (P) may contain, in addition to poly(biphenyl ether sulfone) (P1), at least one poly(aryl ether sulfone) (P2) different from poly(biphenyl ether sulfone) (P1).

Poly(aryl ether sulfone) (P2) can be advantageously chosen from polysulfones, polyethersulfones and polyetherethersulfones.

Polyetherethersulfones, as herein defined, are polycondensation polymers of which more than 50 mol. % of the recurring units are:

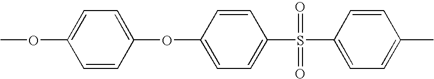

Polyethersulfones, as herein defined, are polycondensation polymers of which more than 50 mol. % of the recurring units are:

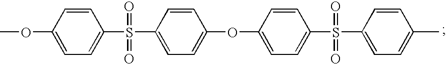

said polyethersulfones may optionally further comprise less than 50 mol. % of recurring units

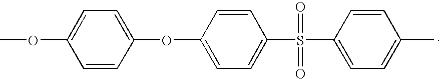

Polyethersulfones are available as RADEL® A from Solvay Advanced Polymers, L.L.C.

Polysulfones, as herein defined, are polycondensation polymers of which more than 50 mol. % of the recurring units are:

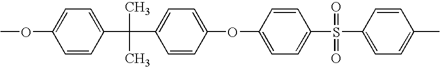

Polysulfones are available as UDEL® PSF from Solvay Advanced Polymers, L.L.C.

Poly(aryl ether sulfone) (P2) is preferably chosen from polyethersulfones and polyetherethersulfones, and more preferably from polyethersulfones.

For certain preferred invented films, the weight of poly(aryl ether sulfone) (P2), based on the total weight of poly(aryl ether sulfone) material (P), ranges from 25 to 75%, and more preferably from 40 to 60%.

For certain other preferred invented films, poly(aryl ether sulfone) material (P) is free of poly(aryl ether sulfone) (P2). Thus, in said films, poly(aryl ether sulfone) material (P) is composed of poly(biphenyl ether sulfone) (P1).

Polymers (P1) and (P2) are advantageously amorphous.

The fluorocarbon Polymer.

For the purpose of the present invention, a fluorocarbon polymer is intended to denote any polymer of which more than 50 mol. % of the recurring units are derived from at least one ethylenically unsaturated monomer comprising at least one fluorine atom (hereafter, “the fluorinated monomer”).

Preferably more than 90 mol. % of the recurring units of the fluorocarbon polymer are derived from the fluorinated monomer.

Still more preferably, all the recurring units of the fluorocarbon polymer are derived from the fluorinated monomer.

The fluorinated monomer may be chosen from perfluorinated monomers such as octafluorobutenes, hexafluoropropylene, tetrafluoroethylene and perfluoralkylvinylethers (e.g. perfluoromethylvinylether and perfluoroproylvinylether), and non perfluorinated monomers such as trifluoroethylene, chlorotrifluoroethylene and vinylidene fluoride.

The fluorinated monomer is preferably tetrafluoroethylene or a mixture of tetrafluoroethylene with at least one perfluorinated monomer (other than tetrafluoroethylene).

The fluorinated monomer is more preferably tetrafluoroethylene.

Good results were obtained when the fluorocarbon polymer was a homopolymer of tetrafluoroethylene (“PTFE”).

Excellent results were obtained when the fluorocarbon polymer was a non fibrillating PTFE (also referred to as “low molecular weight PTFE” or “low melt viscosity PTFE”).

The non fibrillating PTFE has an average molecular weight in number of preferably below 700,000 (as determined by conventional GPC technique).

Besides, the non fibrillating PTFE has preferably an average molecular weight in number of preferably above 50,000 (as determined by conventional GPC technique).

The non fibrillating PTFE has preferably a melt viscosity of below 10⁴ Pa·s, as measured at 372° C. in accordance with the procedure ASTM D1239-52T, modified as disclosed in U.S. Pat. No. 4,380,618.

The non fibrillating PTFE is preferably obtained by irradiation degradation of a high molecular weight homopolymer of tetrafluoroethylene (typically, with an average molecular weight in number above 2,000,000), or directly by polymerization technique such as disclosed in example 1 of U.S. Pat. No. 5,223,343.

The non fibrillating PTFE is usually in the form of finely divided solids, and is then commonly referred to as “PTFE micropowder”. The finely divided solids have an average particle size of preferably less than 100 μm, more preferably less than 20 μm, still more preferably less than 10 μm and the most preferably less than 5 μm.

The non fibrillating PTFE has preferably the thermal stability, chemical inertness, lubricity, and high melting temperature similar to high molecular weight PTFEs.

An especially suitable non fibrillating PTFE is POLYMIST® F5A PTFE, commercially available from Solvay Solexis, Inc. Other suitable non fibrillating PTFEs are commercially available notably from DuPont as ZONYL® PTFE (e.g. ZONYL® MP1600 grade), and from Daikin Industries, Ltd. as LUBLONO (e.g. LUBLON® L-5 PTFE).

The weight of the fluorocarbon polymer, based on the weight of poly(aryl ether sulfone) material (P), is advantageously at least 1.0%, preferably above 2.5%, and still more preferably above 4.0%.

Besides, the weight of the fluorocarbon polymer, based on the weight of poly(aryl ether sulfone) material (P), is advantageously at most 30%, preferably below 18%, and still more preferably below 12%.

### Optional Ingredients.

### (1) Anhydrous Zinc Borate and Other Inorganic Flame Retardants.

Polymer composition (C) may optionally further comprise anhydrous zinc borate. The anhydrous zinc borate over fluorocarbon polymer weight ratio (q₁) is advantageously such that:

0≦q1≦50%.

As described in U.S. Pat. No. 5,204,400, anhydrous zinc borate (i.e. zinc borate with less than 0.2 wt. % of water, and preferably with no measurable water content like XPI-187 zinc borate from U.S. Borax) is a suitable flame retardant agent of poly(biphenyl ether sulfone) compositions, and it is further known that it can be used profitably in combination with a fluorocarbon polymer.

The Applicant has surprisingly found that thin films made poly(biphenyl ether sulfone) compositions which are free of anhydrous zinc borate or, if not, which contain anhydrous zinc borate at a reduced level when compared to the level of the fluorocarbon polymer (i.e. with the ratio q₁ within the above specified range), exhibit a further improved balance of properties. In particular, the Applicant noted a further improvement as concerns the surface aspect of the thin film: while flame retarded poly(biphenyl ether sulfone) compositions with (even quite) anhydrous zinc borate in a ratio q₁>50% may sometimes provide thin films with a substantial number of undesirable bumps (said bumps differing completely in nature and origin from the splays and cracks which are known to be possibly caused by hydration water of zinc borate), the thin films made from the same compositions except the ratio q₁ is now within the range 0≦q₁≦50%, were essentially free, or even totally free, of bumps. The thinner the film is, the higher the improvement was.

Weight ratio q₁ is preferably below 30%, and more preferably below 10%. Still more preferably, q₁ is equal to 0; otherwise said, polymer composition (C) is then free of anhydrous zinc borate.

The weight of anhydrous zinc borate, based on the weight of poly(aryl ether sulfone) material (P), is advantageously below 4.0%, preferably below 2.0%, and more preferably below 1.0%. Still more preferably, polymer composition (C) is free of anhydrous zinc borate, as previously described.

More generally, should polymer composition (C) contain inorganic flame retardants, their weight should advantageously be low when compared to the weight of the fluorocarbon polymer. Accordingly, it is advantageous that the inorganic flame retardant over fluorocarbon polymer weight ratio (q′₁) is such that:

0≦q′₁≦60%.

Weight ratio q′₁ is preferably below 30% and more preferably below 10%.

The weight of inorganic flame retardant, based on the weight of poly(aryl ether sulfone) material (P), is advantageously below 6.0%, preferably below 3.0%, and more preferably below 1%.

### (2) Titanium Dioxide.

Optinally, polymer composition (C) may further comprise titanium dioxide.

As described in notably in U.S. Pat. No. 5,204,400 and U.S. Pat. 5,916,058, titanium dioxide can be used as a pigment of poly(biphenyl ether sulfone) compositions, and it is further known that it can be profitably combined with a fluorocarbon polymer, to provide efficiently pigmented and flame-retarded compositions.

Despite of its possible beneficial effect on flame-retardancy (in combination with a fluoropolymer), titanium dioxide is usually not qualified per se as an inorganic flame-retardant, and, for the purpose of the present invention, it is not an inorganic flame-retardant.

The titanium dioxide used in polymer composition (C) is commercially available.

The particle size of the titanium dioxide is advantageously below 5.0 μm, because higher particle sizes can notably affect the physical properties of polymer composition (C).

Any of the available crystalline forms of the titanium dioxide may be used, with the rutile form preferred due to its superior pigment properties.

The Applicant has found that, among the invented films, a further improvement is still achieved by optimizing the titanium dioxide over fluorocarbon polymer ratio (q₂).

In particular, the Applicant noted a possible further improvement as concerns the surface aspect (e.g. bump level) and/or the tear resistance of the invented film.

Thus, the titanium dioxide over fluorocarbon polymer weight ratio (q₂) is advantageously such that:

0≦q₂≦150%.

In certain preferred invented films, weight ratio (q₂) is between 50 and 125%; more preferably, it is between 50 and 100%.

In certain other preferred invented films, weight ratio (q₂) is up to 50%; more preferably, polymer composition (C) is free of titanium dioxide.

For similar reasons, the weight of titanium dioxide, based on the weight of poly(aryl ether sulfone) material (P), is advantageously below 8.0%.

In certain preferred invented films, the weight of titanium dioxide, based on the weight of poly(aryl ether sulfone) material (P), is preferably between 2.0 and 6.0%; more preferably, it is between 3.0 and 5.0%.

In certain other preferred invented films, the weight of titanium dioxide, based on the weight of poly(aryl ether sulfone) material (P), is up to 5.0%; more preferably, polymer composition (C) is free of titanium dioxide.

### (3) Inorganic Heat Stabilizers

Polymer composition (C) further comprises advantageously at least one inorganic stabilizer.

The inorganic stabilizer is preferably a metal oxide; more preferably, it is zinc oxide.

The inorganic stabilizer over fluorocarbon polymer weight ratio (q3) is advantageously such that:

0≦q₃≦50%.

Weight ratio (q₃) is preferably between 1 and 20%; more preferably, it is between 2 and 10%.

The weight of heat stabilizer, based on the weight of poly(aryl ether sulfone) material (P), is preferably between 0.1 and 2.0%; more preferably, it is between 0.2 and 1.0%.

### (4) Other Ingredients

Polymer composition (C) may further comprise other conventional ingredients of sulfone polymer compositions. These ones are usually chosen from:
inorganic compounds (IC) other than those previously cited,
organic non polymeric compounds (OC) such as organic antioxidants, and
organic polymers (P3) other than (P1) and (P2), e.g. melt-processible polyimides and poly(aryl ether ketone)s.

The inorganic compounds (IC) over fluorocarbon polymer weight ratio (q4) is advantageously such that:

0≦q₄≦50%.

The weight of inorganic compounds (IC), based on the weight of poly(aryl ether sulfone) material (P), is advantageously below 2.0%.

Preferably, polymer composition (C) is free of inorganic compounds (IC).

The overall weight of (IC), (OC) and (P3) ingredients is advantageously below 25 wt. %, based on the weight of poly(aryl ether sulfone) material (P); it is preferably below 5 wt. %; more preferably, polymer composition (C) is free of ingredients (IC), (OC) and (P3).

The polymer composition is advantageously prepared by any conventional mixing method. A preferred method comprises dry mixing the ingredients of polymer composition (C) in powder or granular, using e.g. a mechanical blender, then extruding the mixture into strands and chopping the strands into pellets.

Suitable techniques to make the film according to the present invention are well known from the skilled person. For example, the invented film can in principle be made by solvent casting [this process comprises dissolving polymer composition (C) in a solvent to obtain a solution, laying the so-obtained solution on a labile substrate to form a film and removing the so-formed film from the labile substrate]. However, the invented film is usually made by melt processing, and preferably by extrusion processing.

In the extrusion process, polymer composition (C) is advantageously dried before being extruded. The drying may take place in a dehumidifying oven. The drying temperature ranges advantageously from 135° C. to 165° C., and is typically of about 150° C. The drying time ranges advantageously from 6 to 24 hours, depending notably on the drying temperature, and is typically of about 12 hours. Among many other suitable extruders and dies, a 25 mm Optical Control Systems Model 20/26 Extruder performs well. As well known from the skilled person, the temperature of the heat zones of the extruder are usually adapted as a function of a.o. the chemical nature of the polymer composition to be extruded, here polymer composition (C). For example, for a polymer composition in which the poly(aryl ether sulfone) material is composed of a RADEL® R poly(biphenyl ether sulfone) neat polymer, the heat zones of the extruder are preferably at least 360° C., and more preferably at least 370° C.; besides, they are preferably at most 390° C., and more preferably at most 380° C. All the heat zones of the extruder may be set at the same temperature. As it is also well know from the skilled in the art, the screw rate of the extruder is usually adapted as a function of a.o. the thickness of the film. Generally, the thinner the film is, the lower the screw rate is. The film is advantageously cast onto two or more sequential chill rolls, said chill rolls being maintained at a temperature, which ranges preferably from 220 to 240° C. when the poly(aryl ether sulfone) material is composed of a RADEL® R poly(biphenyl ether sulfone) neat polymer.

The present invention concerns thus also a process for making the invented film, which comprises melt processing polymer composition (C). Preferably, the invented process comprises the step of extruding polymer composition (C).

The present invention further concerns a shaped article comprising the film as above described or prepared by the process as above described.

The invented shaped article comprises advantageously, and preferably consists of,
a bagging part consisting of the film, and
a material (Z), said material (Z) being wrapped by the bagging part.

The bagging part is advantageously closed, possibly through sealing.

The material is advantageously in divided form, such as in particulate or in fibrous form. It is preferably a fiber. Very preferably, it is glass fiber.

The present invention further concerns a polymer composition, which is especially suitable for making the invented film. Said polymer composition, hereafter the invented polymer composition, is one containing:
a poly(aryl ether sulfone) material (P), composed of
   at least one poly(biphenyl ether sulfone) (P1), or
   at least one poly(biphenyl ether sulfone) (P1) and at least one poly(aryl ether sulfone) (P2) different from poly(biphenyl ether sulfone) (P1), and
at least one fluorocarbon polymer, and
optionally, anhydrous zinc borate and/or titanium dioxide,
   wherein:
the anhydrous zinc borate over fluorocarbon polymer weight ratio (q₁) is such that:

0≦q₁≦50%,
the titanium dioxide over fluorocarbon polymer weight ratio (q₂) is such that:

0≦q₂≦150%, and
poly(aryl ether sulfone) material (P) is contained in the polymer composition in an amount of more than 70 wt. %, based on the total weight of the polymer composition.

Except the above mentioned peculiarities, the invented polymer composition meets preferably all the preferred features of polymer composition (C), whatever the level of preference expressed.

The invented polymer composition was advantageously used for making films, more particular thin films, but, more generally, it proved also useful for making various articles, preferably filaments, sheets and hollow bodies. Thus, a last aspect of the present invention concerns said articles.

The invention will be better understood by consideration of the following examples which are provided by way of illustration and not in limitation thereof.

### EXAMPLES

### According to the Invention

### Preparation of Polymer Compositions.

Polymer compositions (a), (b) and (c) were prepared in the form of pellets.

Said polymer compositions consist respectively of:

| | Polymer | Polymer | Polymer |
|---|---|---|---|
| Ingredient | composition (a) | composition (b) | composition (c) |
| RADEL ® R 5200 | 94.85 | 91.10 | 86.30 |
| poly(biphenyl | | | |
| ether sulfone) | | | |
| [neat polymer] | | | |
| Polymist ® F5A | 2.95 | 4.80 | 9.60 |
| non fibrillating | | | |
| PTFE | | | |
| Rutile titanium | 1.95 | 3.85 | 3.85 |
| dioxide | | | |
| Zinc oxide | 0.25 | 0.25 | 0.25 |

The so-obtained pellets were then extruded so as to obtain films having a thickness of 12 μm, as described hereafter.

Extrusion of the Polymer Compositions into Films Having a Thickness of About 12 μm.

The pellets were dried in a dehumidifying oven at 150° C. overnight for approximately 12 hours. The pellets were extruded into films using a 25 mm Optical Control Systems Model 20/26 Extruder with a 10.16 cm wide die. The heat zones were all set at 375° C. to achieve a melt of approximately 375° C., and the extruder screw was rotated at 3 rpm. Film was cast onto two sequential chill rolls the first maintained at 225° C. and the other at 220° C. Film was taken up at approximately 2.0 m/min and was about 8.32 cm wide and 12 μm thick.

Evaluation of the 12 μm-Films.

The films exhibited a superior balance of properties, in substantial progress from the prior art films. Notably, among other properties at a high level, the films had high toughness, including after exposure to moisture condensate, high tear resistance, high flame retardancy and a regular surface aspect; in particular, they were free of bumps, in contrast with some prior art films made from some commercial Radel® R poly(biphenyl ether sulfone) fire-resistant grades.

Extrusion of the Polymer Compositions into Films Having a Thickness of About 6 μm.

Films having a thickness of 6 μm are produced by extruding the pellets of polymer compositions (a), (b) and (c).

1. A film having a thickness of below 100 μm, comprising a polymer composition (C) comprising
a poly(aryl ether sulfone) material (P), composed of
at least one poly(biphenyl ether sulfone) (P1), or
at least one poly(biphenyl ether sulfone) (P1) and at least one poly(aryl ether sulfone) (P2) different from poly(biphenyl ether sulfone) (P1), and
at least one fluorocarbon polymer.

2. The film according to claim 1, wherein the thickness of the film is between 2 μm and 20 μm.

3-6. (canceled)

7. The film according to claim 1, wherein the film comprises the polymer composition (C), and wherein the polymer composition (C) comprises the poly(aryl ether sulfone) material (P) in an amount of more than 50 wt. %.

8. (canceled)

9. The film according to claim 1, wherein more than 50 mol. % of the recurring units of the poly(biphenyl ether sulfone) (P1) are recurring units (R1)comprising at least one ether group (—O—), at least one sulfone group (—SO₂—) and at least one p-biphenylene group:

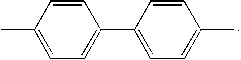

10. The film according to claim 9, wherein the recurring units (R1) are:

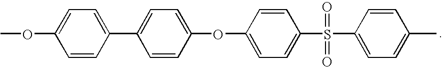

11. (canceled)

12. The film according to claim 10, wherein the poly(biphenyl ether sulfone) (P1) is a homopolymer of the recurring units (R1).

13. The film according to claim 1, wherein the poly(aryl ether sulfone) material (P) is composed of the poly(bisphenyl ether sulfone) (P1) and the poly(aryl ether sulfone) (P2), said poly(aryl ether sulfone) (P2) being selected from the group consisting of polysulfones, polyethersulfones and polyetherethersulfones.

14. (canceled)

15. The film according to claim 1, wherein the poly(aryl ether sulfone) material (P) is composed of the poly(biphenyl ether sulfone) (P1).

16. The film according to claim 1, wherein all the recurring units of the fluorocarbon polymer are derived from at least one fluorinated monomer.

17. The film according to claim 16, wherein the fluorinated monomer is tetrafluoroethylene or a mixture of tetrafluoroethylene with at least one perfluorinated monomer.

18. (canceled)

19. The film according to claim 17, wherein the fluorocarbon polymer is a non fibrillating homopolymer of tetrafluoroethylene.

20. The film according to claim 1, wherein the weight of the fluorocarbon polymer, based on the weight of the poly(aryl ether sulfone) material (P), is at least 1.0% and below 18%.

21. (canceled)

22. The film according to claim 1, wherein the polymer composition (C) further comprises anhydrous zinc borate, the anhydrous zinc borate over fluorocarbon polymer weight ratio (q₁) being such that
q₁≦50%.

23. The film according to claim 1, wherein the polymer composition (C) is free of anhydrous zinc borate.

24. The film according to claim 1, wherein the polymer composition (C) further comprises titanium dioxide, the titanium dioxide over fluorocarbon polymer weight ratio (q₂) being such that
q₂<150%.

25-26. (canceled)

27. A process for making the film according to claim 1, which comprises the step of extruding polymer composition (C).

28. A shaped article comprising the film according to claim 1.

29. The shaped article according to claim 28, which comprises
a bagging part comprising of the film, and
a material (Z), said material (Z) being wrapped by the bagging part.

30. The shaped article according to claim 29, wherein the material (Z) is glass fiber.

31. A polymer composition, comprising:
a poly(aryl ether sulfone) material (P), composed of
at least one poly(biphenyl ether sulfone) (P1), or
at least one poly(biphenyl ether sulfone) (P1) and at least one poly(aryl ether sulfone) (P2) different from poly(biphenyl ether sulfone) (P1), and
at least one fluorocarbon polymer
wherein:
either the polymer composition is free of anhydrous zinc borate, or it contains anhydrous zinc borate, the anhydrous zinc borate over fluorocarbon polymer weight ratio (q₁) being such that
q₁≦50%,
the polymer composition further comprises titanium dioxide, the titanium dioxide over fluorocarbon polymer weight ratio (q₂) being such that
q₂≦150%, and
the polymer composition comprises the poly(aryl ether sulfone) material (P) in an amount of more than 70 wt. %, based on the total weight of the polymer composition.
